(19) United States
(12) Patent Application Publication
(10) Pub. No.: US 2025/0178023 A1
(43) Pub. Date: Jun. 5, 2025

(54) SYSTEMS AND METHODS OF CONTROLLING ADHESIVE APPLICATION

(71) Applicant: Nordson Corporation, Westlake, OH (US)

(72) Inventor: Peter W. ESTELLE, Duluth, GA (US)

(73) Assignee: Nordson Corporation, Westlake, OH (US)

(21) Appl. No.: 18/845,020

(22) PCT Filed: Mar. 20, 2023
(86) PCT No.: PCT/US2023/015635

§ 371 Date: Sep. 9, 2024

Related U.S. Application Data
(60) Provisional application No. 63/321,939, filed on Mar. 21, 2022.

(51) Int. Cl. B05C 11/10

(52) U.S. Cl. CPC B05C 11/1005; B05C 11/1013; B05C 11/1023

(57) ABSTRACT

A method and system for controlling and providing a more consistent material application amount includes implementing a conveyor configured to convey substrates along a dispense line at a speed; implementing an application device configured to apply a desired amount of a material to each of the substrates; implementing a pump configured to deliver the material at a pressure to the application device; implementing a controller configured to receive a desired speed of the conveyor and control a speed of the conveyor to convey the substrates along the dispense line at the desired speed; determining with the controller a target pressure of the material provided by the pump to the application device to provide the desired amount of the material to each of the substrates utilizing a control algorithm; measuring an amount of material applied to a plurality of substrates by a pump; comparing the material applied per substrate to a target value; and adjusting a pressure of the pump based on the comparing the material applied per substrate to a target value.

### CROSS REFERENCE TO RELATED APPLICATIONS

This application is a National Stage Application of International Patent App. No. PCT/US2023/015635, filed Mar. 20, 2023, which claims the benefit of U.S. Provisional Patent App. No. 63/321,939, filed Mar. 21, 2022, the entire disclosures of both of which are hereby incorporated by reference as if set forth in their entirety herein.

### TECHNICAL FIELD

The disclosure relates generally to systems and processes for controlling material application.

### BACKGROUND

The amount of material, such as adhesive, applied to a substrate is often critical. For example, ensuring that a proper amount of adhesive is applied to packaging may substantially affect the sale of a packaged good. On one hand, applying too much adhesive to the packaging may increase the cost of the packaged good, while also possibly reducing the aesthetics by having the adhesive “squeeze-out” of joints. In this regard, squeeze-out can also get material, such as adhesive or glue, on parts of a production line and foul the production line causing downtime. On the other hand, applying too little adhesive may compromise the integrity of the packaging, possibly causing damage to the packaged goods. Even a few of these deficiencies may cause an entire production run of products to be rejected by a prospective buyer.

In this regard, customers desire the same amount of dispensed material, such as adhesive, on each product. Stated alternately, the amount of dispensed material, such as adhesive, per unit length and/or per product should be generally the same regardless of the line speed of the dispense lines of the system and/or other factors listed in FIG. 9. Current systems do not provide sufficient control in applying adhesive to substrates.

Therefore, it would be desirable to provide a system configured to control material application.

### SUMMARY

The foregoing needs are met, to a great extent, by the systems and processes described herein.

One aspect includes a method for controlling material application in a material dispensing system, the method includes implementing a conveyor configured to convey substrates along a dispense line at a speed; implementing an application device configured to apply a desired amount of a material to each of the substrates; implementing a pump configured to deliver the material at a pressure to the application device; implementing a controller configured to receive a desired speed of the conveyor and control a speed of the conveyor to convey the substrates along the dispense line at the desired speed; determining with the controller a target pressure of the material provided by the pump to the application device to provide the desired amount of the material to each of the substrates utilizing a control algorithm; measuring an amount of material applied to a plurality of substrates by a pump; comparing the material applied per substrate to a target value; and adjusting a pressure of the pump based on the comparing the material applied per substrate to a target value.

One aspect includes a material dispensing system, the material dispensing system includes a conveyor configured to convey substrates along a dispense line at a speed; an application device configured to apply a desired amount of a material to each of the substrates; a pump configured to deliver the material at a pressure to the application device; a controller configured to receive a desired speed of the conveyor and control a speed of the conveyor to convey the substrates along the dispense line at the desired speed; the controller configured to determine a target pressure of the material provided by the pump to the application device to provide the desired amount of the material to each of the substrates utilizing a control algorithm; a flow sensor configured to measure an amount of material applied to a plurality of substrates by a pump; the controller configured to compare the material applied per substrate to a target value to generate a comparison value; and the controller configured to adjust a pressure of the pump based on the comparison value.

### BRIEF DESCRIPTION OF THE DRAWINGS

In order that the disclosure may be readily understood, aspects of this disclosure are illustrated by way of examples in the accompanying drawings.

FIG. 1 illustrates a diagrammatic view of an exemplary material dispensing system.

FIG. 2 illustrates an exemplary system implementation diagram of the material dispensing system according to an aspect of the disclosure.

FIG. 3A illustrates a material dispensing system closed loop process according to an aspect of the disclosure.

FIG. 3B illustrates test results of an application of material by the material dispensing system with a closed loop flow control according to the disclosure and test results of an application of material by the material dispensing system with no flow control.

FIG. 4 illustrates a schematic of a material dispensing system according to aspects of the disclosure.

FIG. 5 illustrates an exemplary calibration process according to the disclosure.

FIG. 6 illustrates exemplary graph results of an application of material by the material dispensing system after a calibration process according to the disclosure.

FIG. 7 illustrates a diagrammatic view of an exemplary material dispensing system.

FIG. 8 illustrates an exemplary schematic view of a control system according to the disclosure.

FIG. 9 illustrates factors that can cause an add-on amount in a control system to vary.

FIG. 10 provides a diagram illustrating an unexceptional approach.

The same reference numbers are used in the drawings and the following detailed description to refer to the same or similar parts.

### DETAILED DESCRIPTION

The disclosure is directed to precision dispense and discloses a new paradigm in material application systems, such as hot melt systems, using flow measurement technology, such as a flowmeter, a built-in flowmeter, and/or the like.

The disclosed process and system may be especially valuable for installations with variable production line speeds. However, the disclosed process and system can work for fixed production line speeds as well.

Customers desire the same amount of material, such as adhesive, on each product since the adhesive quantity determines the bond strength. Stated alternately, the amount of adhesive per unit length should be the same regardless of the line speed. In particular, customers desire a consistent amount of material dispensed, such as adhesive, on each of a plurality of substrates or products. As further described below, the disclosure makes general reference to flow rate of material dispensed to provide a high level teaching of the disclosed process and system that may be applicable to a continuous bead on an infinite length product. However, the teachings of this general reference to flow rate are applicable and may be utilized by the disclosed system and process for discrete products. In particular, material flow may be intermittent to skip gaps between a plurality of products or substrates being processed. For example, to apply two beads of the material to a product or substrate in a line with one or more “gaps” in between products or substrates. This application of material may be referred to as a “pattern.” Once the application of material is cut up or accounted for “per product,” this may be referred to as “add-on weight.” The disclosed system and process is configured to provide a more consistent add-on weight from product to product for such intermittent application. However, having a more consistent add-on weight from product to product may not quite be sufficient for certain implementations. For example, the disclosed system and process may be configured to provide a uniform bead or application of material along an applied length of the product or substrate. In this regard, a non-uniform application of material having a same total weight may not be desirable. In other words, an application of material with a big blob at one end and a thin string at the other end that just happened to have the same total weight. It would be advantageous to enable this amount of adhesive to be directly set by the user and then explicitly controlled in a closed loop.

However, in typical systems the desired adhesive output amount is indirectly set by the user via pump pressures or motor speed in order to result in the system providing the desired output of adhesive. In this regard, these typical systems do not set this “add-on” weight (or volume) directly. Moreover, in the typical systems the control loop is “open,” which is to say there is no feedback and/or correction that maintains the desired output as conditions change.

Even with existing systems with flow measurement, the setup is implemented above, but with the convenience of a “flow readout.” Even with the typical runup, the system is open loop. Accordingly, output will vary as conditions change.

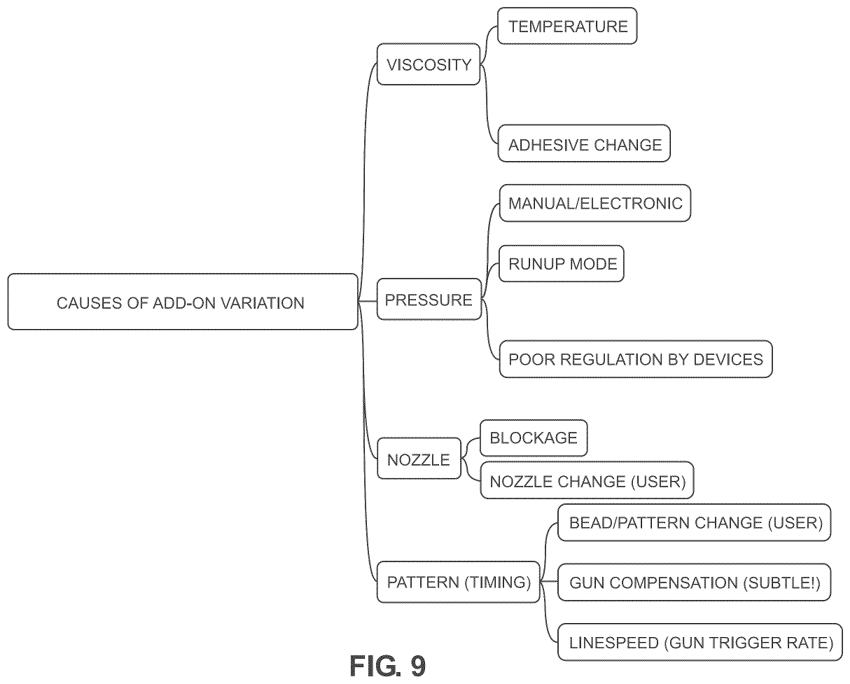

The disclosed system and process actively works to maintain the desired amount of adhesive applied to the product. In this regard, a list of factors that can cause the add-on amount to vary is shown in FIG. 9.

The disclosure utilizes various terminology and a meaning of this terminology can vary. Accordingly, this terminology is noted below together with a definition and may be utilized in this disclosure somewhat interchangeably even though they are distinct:
flow—what comes out of the system to be applied to the substrate.
flowrate—technically applies to continuous flow. In this regard, flowrate should scale proportionally with a line speed in order to apply the same amount to each product.
add-on—is an amount of material, such as adhesive applied to each product. In this regard, generally a constant is desired.
   The specific meaning of the terminology should be clear, or inferred, from a context utilized in this disclosure.

As described in this disclosure, add-on amount may be one of the key quantities that determines the strength of adhesive bond. In this regard, the disclosed system and process is configured such that the user may directly enter an “add-on” target (or setpoint) similar to a temperature setpoint. The disclosed system and process then operates to maintain that specified output with a closed loop feedback system based on add-on (flow). In this regard, the add-on is the quantity that determines the adhesive bond.

For example, a system may operate in the following scenario: The system is operated at a temperature setpoint of 350 degrees F.; and the adhesive has certain properties, such as viscosity, at that temperature. Those properties affect the flow vs. pressure relationship. The system is adjusted such that the flow output (Qout) is as desired. At some later point, the temperature setpoint of the system is changed slightly. This will un-intentionally change the add-on weight provided by the system by approximately 7% for a 5 degree F. change in temperature when using a typical packaging grade adhesive. The system output is close to correct, but no longer correct. The disclosed system and process will respond to the deviation in add-on weight by changing pressure in order to bring the add-on back to the desired value at the new temperature.

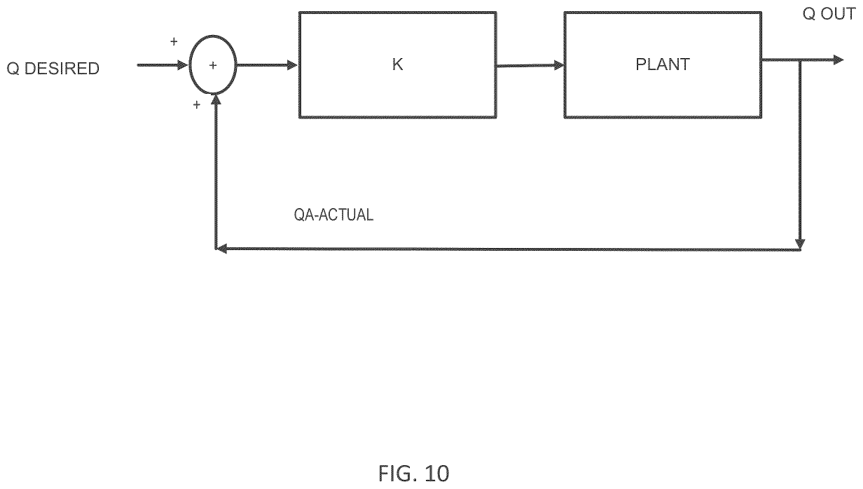

Conceptually, the diagram illustrated in FIG. 10 conveys the high level idea. It might seem tempting to implement a system consistent with this diagram. However, directly implementing this would have some difficulties, especially for variable line speeds. Accordingly, the disclosure implements a better performing and more practical system as further described herein.

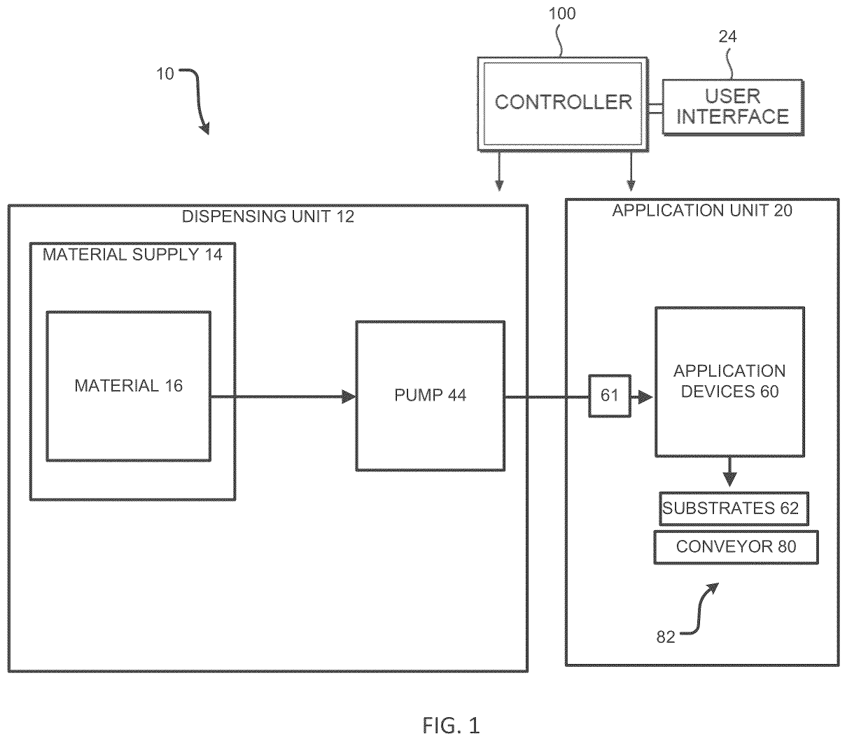

FIG. 1 illustrates a diagrammatic view of an exemplary material dispensing system.

In particular, FIG. 1 illustrates a material dispensing system 10 that may be configured to control an amount of material, such as adhesive, applied per substrate utilizing a closed loop control. In aspects, the material dispensing system 10 may be implemented as a hot melt adhesive system. Hereinafter, the material utilized by the material dispensing system 10 may be referred to as adhesive. However, the disclosed implementation of the material dispensing system 10 is equally applicable to any type of material that may be applied to a substrate.

Referring to FIG. 1, the material dispensing system 10 may include a dispensing unit 12 and an application unit 20. The dispensing unit 12 may further include a material supply 14 configured to receive a material 16, a pump 44 configured to receive the material 16 from the material supply 14 and propel the material 16 to the application unit 20. The operation of the dispensing unit 12 and/or the application unit 20 may be controlled by a controller 100 and/or a user interface 24.

The application unit 20 may include one or more application devices 60 configured to apply the material 16 to one or more substrates 62 positioned on a support. In aspects, the one or more application devices 60 may be guns, glue guns, adhesive guns, and/or the like. In some aspects, the application unit 20 may include a conveyor 80 configured to convey one or more substrates 62 past the one or more application devices 60. Additionally, the application unit 20 may include hoses, nozzles, and/or the like.

The conveyor 80 may be implemented as a conveyor belt, a pneumatic conveyor, a vibrating conveyor, a flexible conveyor, a spiral conveyor, a vertical conveyor, a Motorized Drive Roller (MDR) conveyor, a roller conveyor, a heavy-duty roller conveyor, a walking beam conveyor, a robotic conveyor, and/or the like. The conveyor 80 may be controlled through a signal from the controller 100. In particular aspects, the conveyor 80 may be configured to operate at multiple fixed speeds, variable speeds, and/or continuously variable speeds. Although, multiple fixed speeds, variable speeds, and/or continuously variable speeds may be considered fairly different, the disclosed system and process is configured to operate with each. For example, in aspects the disclosed system and process may be configured to handle multiple fixed speeds discretely, for example, with recipes of operating parameters in conjunction with a calibration process 500 described below. Accordingly, the one or more substrates 62 may be conveyed by the conveyor 80 along an application line at multiple speeds and/or variable speeds on a dispense line 82. In particular, the dispense line 82 may be operated at multiple speeds and/or variable speeds to move the one or more substrates 62 past the one or more application devices 60 for application of the material 16 to the one or more substrates 62.

The pump 44 may be operatively controlled by the controller 100 to deliver the material 16 to the application unit 20 with a pressure. In particular, the pump 44 may deliver the material 16 to the application unit 20 with a variable pressure, which may be in response to input from the user interface 24. The pressure level of the material 16 generated by the pump 44 responsive to the controller 100 may result in the amount of the material 16 applied to the one or more substrates 62 by the one or more application devices 60. In other words, changing the pressure level of the material 16 changes the amount of the material 16 applied to the one or more substrates 62 by the one or more application devices 60. In aspects, the controller 100 may be controlling the pump pressure. In this regard, the pump 44 may be implemented in aspects as a piston pump and controlling the pump pressure may be implemented by controlling an air pressure that drives the pump 44. In this regard, varying the air pressure delivered to the pump 44 causes the pump 44 to vary a pressure level of the material 16, which pressure level of the material 16 may be a glue pressure, a fluid pressure, a hydraulic pressure, and/or the like.

Additionally, changing the speed of the dispense line 82 and/or the conveyor 80 changes a time that the one or more substrates 62 is arranged in a position to receive the material 16 from the one or more application devices 60. Accordingly, changing the speed of the dispense line 82 and/or the conveyor 80 changes the amount of the material 16 from the one or more application devices 60 applied to the one or more substrates 62.

In this regard, customers desire the same amount of the material 16 dispensed, such as adhesive, on each of a plurality of the substrate 62 or product. Stated alternately, the amount of the material 16 dispensed, such as adhesive, per unit length should be generally the same regardless of the line speed of the dispense line 82 of the material dispensing system 10.

In order to achieve this goal, the material dispensing system 10 may implement one or more flow sensors 61 configured to generate a signal based on flow rate information. The flow sensors 61 may be positioned in the material dispensing system 10 to measure the flow of the material 16. For example, the one or more flow sensors 61 may be arranged between the pump 44 and the one or more application devices 60. Additionally, the material dispensing system 10 may be configured to accurately vary a pressure of the material 16 to be applied to the one or more substrates 62 based on a line speed of the dispense line 82 and/or the conveyor 80. The disclosed process and system is vastly superior when compared to prior art approaches.

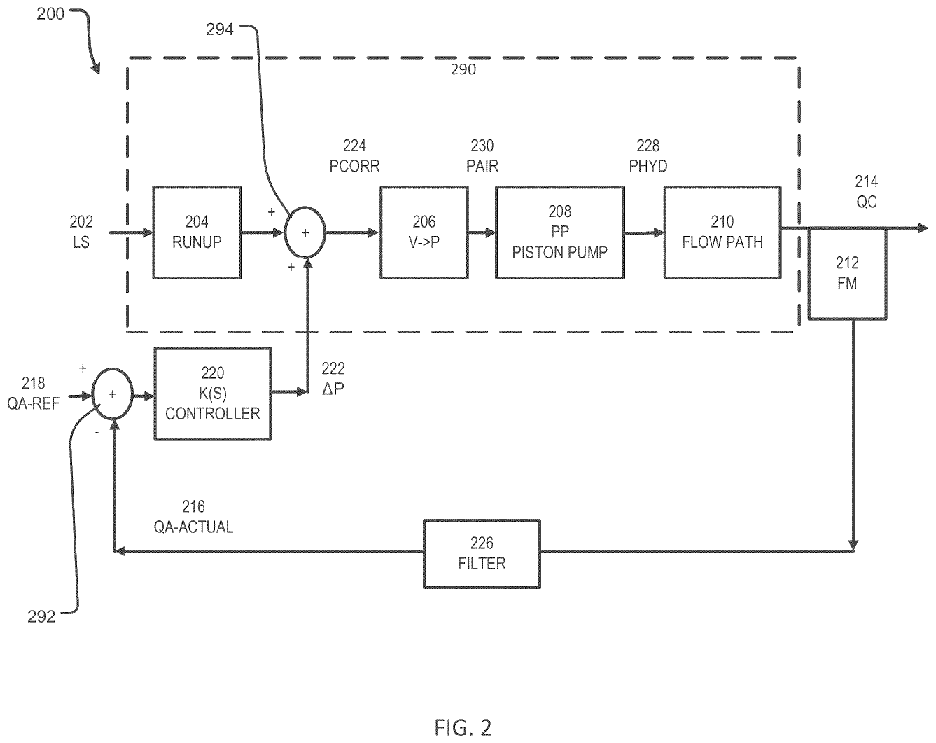

FIG. 2 illustrates an exemplary system implementation diagram of the material dispensing system according to an aspect of the disclosure.

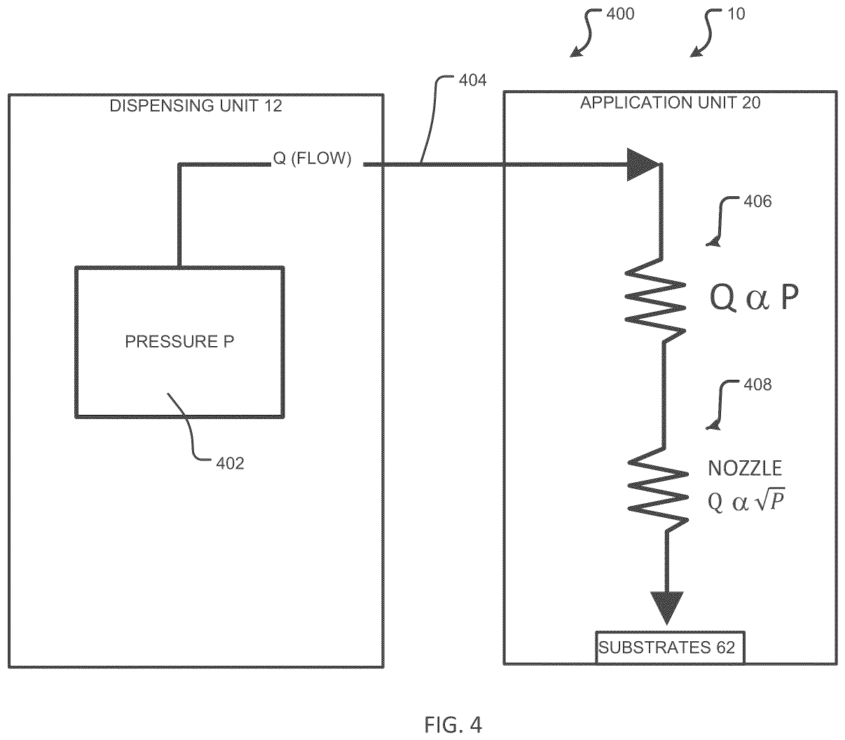

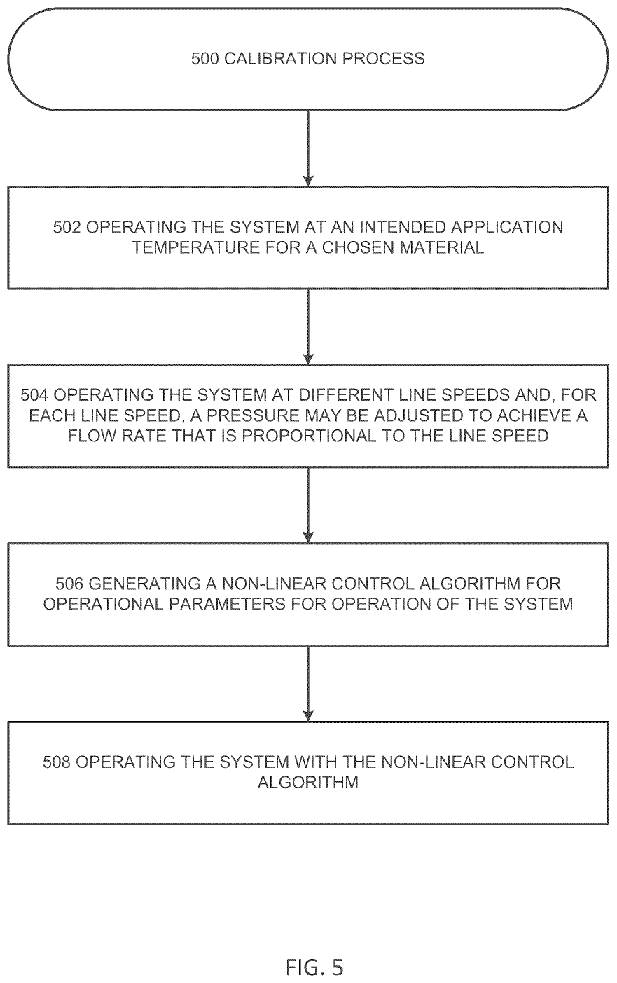

In particular, FIG. 2 illustrates an exemplary system implementation diagram 200 of the material dispensing system 10. In this regard, the material dispensing system 10 may include a line speed input (LS) 202. In this regard, the line speed input (LS) 202 may be input into a runup process component 204 of the material dispensing system 10 to ensure that the material dispensing system 10 is operated consistent with a speed of the conveyor 80 and/or the dispense line 82. The runup process component 204 may be configured to generate a pressure in response to a line speed of the conveyor 80 for further operation of the material dispensing system 10. However, as further described below, the output of the runup process component 204 may be subsequently corrected. Additionally, an exemplary implementation of the runup process component 204 is described in relation to FIG. 4 and FIG. 5 and associated text thereof below.

The output of the runup process component 204 is fed to a voltage to pressure process component V->P 206. The output of the pressure process component V->P 206 may be a signal for operating the pump 44. In aspects, the pressure process component V->P 206 may be implemented as an electronically controlled voltage to pressure transducer and/or a current to pressure transducer.

The output of the pressure process component V->P 206 may be input to a piston pump process component PP 208. The piston pump process component PP 208 may be associated with the pump 44 illustrated in FIG. 1. In aspects, the output of the pressure process component V->P 206 may be an air pressure PAIR 230 for operating the pump 44.

The output of the piston pump process component PP 208 may be input to a flow path process component 210. The flow path process component 210 relates to a hydraulic flow path and/or an adhesive flow path between the pump 44 and an output the material dispensing system 10 such as the one or more application devices 60. Further details of the flow path process component 210 are described in relation to FIG. 4 and the adhesive path 404 illustrated in the system schematic 400. In particular, the output of the piston pump process component PP 208 may be a hydraulic pressure of material PHYD 228, which may be a hydraulic pressure of the material 16.

One or more of the runup process component 204, the pressure process component V->P 206, the piston pump process component PP 208, the flow path process component 210, and/or the like may be operated in the material dispensing system 10 as part of a run-up system 290.

The output from the flow path process component 210 may be a continuous flow output QC 214. In this regard, the output from the flow path process component 210 of the material dispensing system 10 may relate to the output of the material 16 from the one or more application devices 60 illustrated in FIG. 1.

The output from the flow path process component 210 may be monitored by a flow measurement system process FM 212. In this regard, the flow measurement system process FM 212 may include an adhesive tracking system (ATS), the one or more flow sensors 61, and/or the like. The output from the flow measurement system process FM 212 may be a flow QA-actual 216, which may be an actual add-on weight of the material 16 that was applied to the one or more substrates 62 by the one or more application devices 60 of the material dispensing system 10.

As further illustrated in the exemplary system implementation diagram 200 of FIG. 2, the material dispensing system 10 may be configured at least in part by the controller 100 and/or the user interface 24 to receive a desired add-on reference amount QA-ref 218. The desired add-on reference amount QA-ref 218 may be input to the user interface 24, the controller 100, another controller, and/or the like. In this regard, the desired add-on reference amount QA-ref 218 may be the desired add-on or setpoint of the material 16 to be applied to the one or more substrates 62 by the material dispensing system 10.

The desired add-on reference amount QA-ref 218 and the flow QA-actual 216 may be combined in a combiner 292. In this regard, the value of the flow QA-actual 216 may be subtracted from the desired add-on reference amount QA-ref 218 to indicate an error or difference in the amount of the material 16 applied to the one or more substrates 62 by the material dispensing system 10 as illustrated in FIG. 1 or the amount of the continuous flow output QC 214 as illustrated in FIG. 2.

The error or difference output from the combiner 292 may be input to a controller K(s) 220. The controller K(s) 220 may be implemented by the controller 100, may be implemented as a separate controller, such as a Proportional (P) controller, a Proportional-Integral (PI) controller, a Proportional-Derivative (PD) controller, a Proportional-Integral-Derivative (PID) controller, and/or the like.

The output from the controller K(s) 220 may be a pressure correction ΔP 222. The pressure correction ΔP 222 may be input to a combiner 294. In this regard, the pressure correction ΔP 222 may be combined with the pressure signal from the runup process component 204. In particular, the pressure correction ΔP 222 may be summed with the pressure signal from the runup process component 204. Accordingly, the output from the combiner 294 is a corrected pressure PCORR 224 that is combiner fed to the pressure process component V->P 206.

As further illustrated in FIG. 2, in some aspects the material dispensing system 10 may implement a filter 226 as illustrated in the exemplary system implementation diagram 200. In this regard, the filter 226 may or may not be implemented by the material dispensing system 10 as desired and/or needed. In this regard, the filter 226 may “smooth” the discrete and noisy output of the flow measurement system process FM 212. The filter 226 in the feedback path may both help and hurt implementation of the material dispensing system 10. It may help smooth the signal, but it also may introduce lag which can cause oscillations within the material dispensing system 10. Another filter implementation which may be helpful is a filter arranged in the material dispensing system 10 between the flow setpoint, QA-ref, and the summing junction. In particular, between the desired add-on reference amount QA-ref 218 and the combiner 294 in the material dispensing system 10. This may reduce and/or eliminate transients in the feedback loop of the material dispensing system 10. A transition time of 0.5 seconds (time constant about 0.1 seconds) may be sufficient.

The approach set forth in the exemplary system implementation diagram 200 illustrated in FIG. 2 can make good use of the flow path characterization, such as the flow resistance, determined in aspects of the disclosure illustrated in FIG. 4 and FIG. 5 and the text description thereof which describes that this open loop feedforward path calculates the required flow mostly correct—but will naturally have small errors. The feedback loop in the exemplary system implementation diagram 200 is closed on the flow variable (“add-on”) and discrepancies can be overcome by the negative feedback that applies small corrections (ΔP—the corrected pressure PCORR 224) to the pressure from the pressure process component V->P 206. In aspects, the Closed loop control of the material dispensing system 10 can be disabled by setting K(s)=0 for the controller K(s) 220 of the exemplary system implementation diagram 200. Then the material dispensing system 10 is essentially an open loop runup system.

Testing/Results: Exemplary implementations of the material dispensing system 10 operating consistent with the exemplary system implementation diagram 200 have been implemented in software and preliminary testing has yielded impressive results. In this regard, the material dispensing system 10 operated such that the output changed smoothly when an Add-On Target (setpoint) was changed from a 1st mass to a 2nd mass (e.g., 100 mg to 120 mg).

As an example of the closed loop regulation capabilities of the material dispensing system 10: The gun temperature was changed as follows and allowed to settle at each new setpoint: 350 F->250 F->420 F->350 F. Pressure was varied automatically in the material dispensing system 10 by the disclosed algorithm, such as the calibration process 500 and/or the material dispensing system closed loop process 600 as required. The Add-On vs. time was quite constant or “flat” and varied only +/−5 mg despite a rather excessive 170 F temperature change in the gun.

Other tests on the material dispensing system 10 were tried where pressure was changed and pattern timing relative to line speed was changed. The disclosed closed loop control of the material dispensing system 10 was able to regulate the process and greatly reduce the output variation that would have resulted from an open loop.

The disclosed system and process provides a number of advantages. For example, a setting received and controlled by the material dispensing system 10 matches to what the customer cares about, an amount of the material 16, such as glue applied, applied to the substrate 62 and/or a product. Additionally, the disclosed implementation of the material dispensing system 10 results in improved quality of the glue joint and end product. Furthermore, the disclosed implementation of the material dispensing system 10 results in improved economy and/or cost savings that can accrue to the user since the output of the material dispensing system 10 is tightly controlled and little to no excess is needed to void insufficient adhesive as conditions change. Further, the disclosed implementation of the material dispensing system 10 results in greater convenience in that a system complexity in the material dispensing system 10 is “hidden” from the user. Additionally, the disclosed implementation of the material dispensing system 10 results in improved direct control of the key variable under closed loop feedback control within the material dispensing system 10. Further, the disclosed implementation of the material dispensing system 10 is built upon an improved runup system with conventional controls. Additionally, the disclosed implementation of the material dispensing system 10 may utilize diagnostics. Further, the disclosed implementation of the material dispensing system 10 works with both fixed and variable speed lines.

A “simple” closed loop on flow without considering line speed as illustrated in FIG. 10 seems appealing at “first blush”. Such a system might work reasonably well on fixed speed lines. But if there are non-linearities inside a control loop, the system has no idea where on the runup curve it is operating.

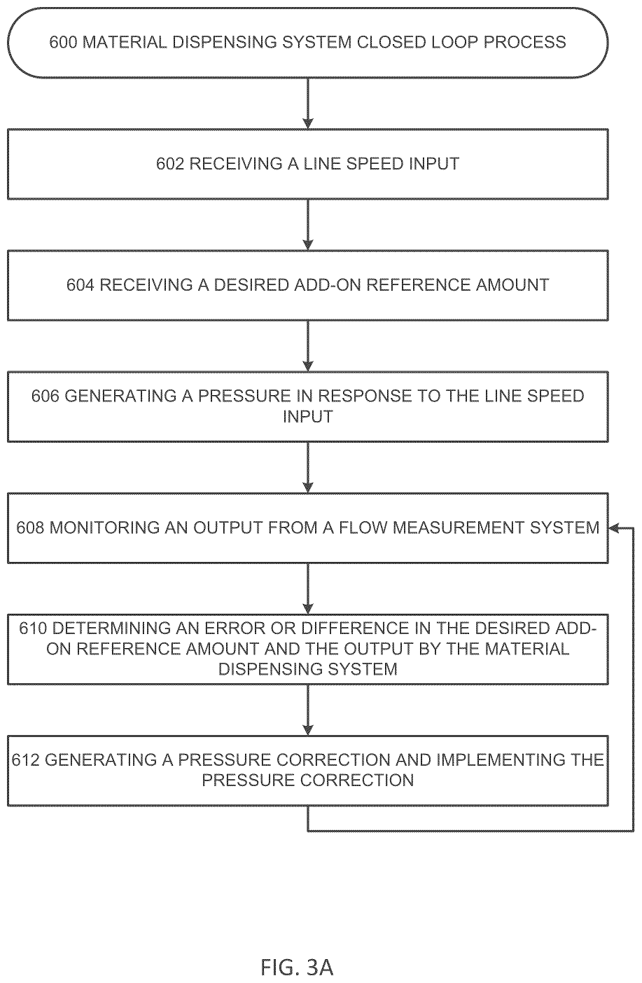

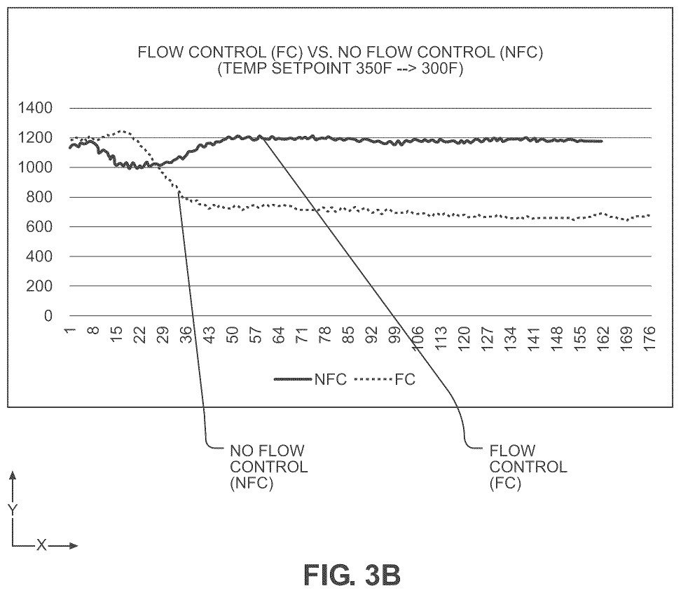

FIG. 3 illustrates a material dispensing system closed loop process according to an aspect of the disclosure.

In particular, FIG. 3 illustrates a material dispensing system closed loop process 600 that may be implemented by the material dispensing system 10, the controller 100, and/or the like. Initially, the material dispensing system closed loop process 600 may include receiving a line speed input 602 that may include the line speed input (LS) 202 as described with reference to FIG. 2.

Additionally, the material dispensing system closed loop process 600 may include receiving a desired add-on reference amount 604. In particular, the material dispensing system closed loop process 600 may include receiving a desired add-on reference amount 604 that may include the desired add-on reference amount QA-ref 218 described with reference to FIG. 2.

Further, the material dispensing system closed loop process 600 may include generating a pressure in response to the line speed input 606. In this regard, the generating a pressure in response to the line speed input 606 may include any one or more of the pressure process component V->P 206, the piston pump process component PP 208, the flow path process component 210, the corrected pressure PCORR 224, the hydraulic pressure of material PHYD 228, the air pressure PAIR 230.

Next, the material dispensing system closed loop process 600 may include monitoring an output from a flow measurement system 608. The monitoring an output from a flow measurement system 608 may include obtaining the flow QA-actual 216 from the filter 226 and/or the flow measurement system process FM 212.

Further, the material dispensing system closed loop process 600 includes determining an error or difference in the desired add-on reference amount and the output by the material dispensing system 610. The determining an error or difference in the desired add-on reference amount and the output by the material dispensing system 610 may include the output of the combiner 292 comparing the desired add-on reference amount QA-ref 218 to the flow QA-actual 216.

Further, the material dispensing system closed loop process 600 may include generating a pressure correction and implementing the pressure correction 612. In aspects, the generating a pressure correction and implementing the pressure correction 612 may include generating the pressure correction ΔP 222, the corrected pressure PCORR 224, and/or the like.

FIG. 3B illustrates test results of an application of material by the material dispensing system with a closed loop flow control according to the disclosure and test results of an application of material by the material dispensing system with no flow control.

In particular, FIG. 3B illustrates test results of an application of the material 16 by the material dispensing system 10 implementing the material dispensing system closed loop process 600 according to the disclosure as illustrated by a FLOW CONTROL (FC) line; and FIG. 3B illustrates test results of an application of the material 16 by the material dispensing system 10 with no flow control according to the disclosure as illustrated by the NO FLOW CONTROL (NFC) line. As illustrated by FIG. 3B, the Y-axis is add-on weight (in grams) of the material 16; and the X-axis is time.

As illustrated in FIG. 3B, the material dispensing system 10 is operated with a 50° F. temperature change as an example of the closed loop regulation capabilities of the material dispensing system 10: Pressure was varied automatically in the material dispensing system 10 by the disclosed algorithm, such as the calibration process 500 and/or the material dispensing system closed loop process 600 as required. Over time, the add-on weight of the material 16 applied by the material dispensing system 10 implementing the material dispensing system closed loop process 600 initially and temporarily deviated about 16% and then subsequently returned to a value approaching the initial value. Implementation of the material dispensing system closed loop process 600 forces the add-on weight back near 1200 mg from about time 50 onward. On the other hand, the application of the material 16 by the material dispensing system 10 with no flow control (NFC) experienced about a 50% deviation that does not change.

Accordingly, implementation of the material dispensing system 10 in conjunction with the material dispensing system closed loop process 600 may operate to provide a proper amount of the material 16, a more consistent amount of the material 16, a greater consistency of an amount of the material 16, and/or the like on each of the substrate 62 or the product relatively independent of operating parameters of the material dispensing system 10 such as those illustrated in FIG. 9. Moreover, the implementation of the material dispensing system 10 in conjunction with the material dispensing system closed loop process 600 may be utilized in various systems having linear components and/or nonlinear components.

In further aspects of the disclosure, the material dispensing system 10 and/or the controller 100 may be implemented with a “velocity form” of PID or another controller with an integrator. In further aspects of the disclosure, the material dispensing system 10 and/or the controller 100 may be implemented with “signal processing” in either hardware or software. In further aspects of the disclosure, the material dispensing system 10 may be implemented with systems with built-in flow measurement of the one or more flow sensors 61. In further aspects of the disclosure, the material dispensing system 10 may be implemented with external flowmeters implementations of the one or more flow sensors 61. In further aspects of the disclosure, the material dispensing system 10 and/or the controller 100 may be implemented with other types of control laws including non-linear control laws, gain scheduled control laws, adaptive control laws, neural network control laws, fuzzy logic control laws, machine learning control laws, and/or the like. In further aspects of the disclosure, the material dispensing system 10 may be implemented with a slightly different approach for continuous flow. In further aspects of the disclosure, the material dispensing system 10 may be implemented such that a desired flow Qdesired and/or the desired add-on reference amount QA-ref 218 may be derived or computed from a scaled function of line speed. In other words, the material dispensing system 10 may be implemented such that a flow is proportional to line speed.

FIG. 4 illustrates a schematic of a material dispensing system according to aspects of the disclosure.

In particular, FIG. 4 illustrates a system schematic 400 that may be a system schematic of the material dispensing system 10 illustrated in FIG. 1. The system schematic 400 is illustrated as having a source of material 402 operated at a pressure P. The source of material 402 may include any one or more of the dispensing unit 12, the material supply 14, the material 16, the pump 44 and/or the like.

The material may flow through the material dispensing system 10 along an adhesive path 404. In particular, the material may flow through the material dispensing system 10 along the adhesive path 404 within the dispensing unit 12, from the dispensing unit 12 to the application unit 20 and through the application unit 20 onto the one or more substrates 62. Additionally, the material dispensing system 10 may connect along the adhesive path 404 to one or more components 406 having a linear relationship of a flow Q to pressure. In this regard, the one or more components 406 are illustrated with the flow Q proportional to pressure P or the flow Q α to pressure P. In this regard, proportional or proportionality can include other factors like scaling constants and/or the like. Examples of the one or more components 406 that may have a linear relationship of a flow Q to pressure may include hoses of the application unit 20.

Moreover the material dispensing system 10 may connect along the adhesive path 404 to one or more components 408 having a non-linear relationship of a flow Q to pressure. For example, the one or more components 408 may have a non-linear relationship with the flow Q such as being proportional to a square root of pressure. In this regard, the one or more components 406 are illustrated with the flow Q proportional to a square root of pressure P or the flow Q α to a square root of pressure P. Examples of the one or more components 408 that may have a non-linear relationship may include nozzles of the application unit 20. Additionally, it is contemplated that one or more components may have another non-linear relationship of the flow Q to the pressure P.

Additionally, it should be noted the dispensing unit 12 may implement the one or more components 406 and/or the one or more components 408 (not illustrated); the application unit 20 may implement the one or more components 406 and/or the one or more components 408 as illustrated; and/or both the dispensing unit 12 and the application unit 20 may implement the one or more components 406 and/or the one or more components 408 (not illustrated). One or more of the source of material 402, the adhesive path 404, the one or more components 406, the one or more components 408, and/or the like may be implemented by one or more components of the material dispensing system 10 illustrated in FIG. 1.

Accordingly, the material dispensing system 10 may have a non-linear relationship between pressure and line speed. In this regard, the disclosed process and system addresses the non-linear relationship between pressure and line speed by characterizing and/or modeling the non-linear flow resistance of the dispensing unit 12, the application unit 20, the one or more components 406, the one or more components 408, the adhesive path 404, and/or the like with a minimum of three points. In this regard, the flow resistance or pressure vs. flow relationship has been found to be non-linear since it is a combination of pressures drops through the material dispensing system 10, not all of which are linear.

The degree of non-linearity may be affected by the relative contribution of a number of factors. The factors may include one or more the following and others that are system dependent: system configuration factors including flow passages in the material dispensing system 10, a chemical formulation of the material 16, an application temperature of the material 16, a viscosity of the material 16, one or more of internal melter flow passages with ATS (adhesive tracking system), one or more of internal melter flow passages without ATS, one or more of internal melter flow passages with ATP, one or more of internal melter flow passages without ATP, and/or the like; adhesive factors including one or more of a chemical formulation, and application temperature, a viscosity, and/or the like; hose factors including one or more of a hose length, a hose diameter, a hose construction, and/or the like; the hose construction may include factors such as heaters or heater types, an insulation type, a thermal efficiency, fitting types, a barrier material type and/or the like; nozzle factors including one or more of a nozzle diameter, a nozzle engagement, such as a nozzle length, and/or the like.

One or more of these above-noted factors as well as others may be linear such as the one or more components 406 of the material dispensing system 10. However, some factors related to certain components of the material dispensing system 10, such as the one or more components 408, which may include nozzles, in particular, can have flow proportional to the square root (SQRT) of pressure which is non-linear.

For example, a curve fit to real pressure data was obtained in the lab at various line speeds for an exemplary implementation of the material dispensing system 10. The table below illustrates that certain non-linear terms or aspects of components of the material dispensing system 10 can have a greater magnitude and/or vary greatly in comparison to the linear terms of components of the material dispensing system 10.

| Non-linear Term | Linear Term |
|---|---|
| 13.15 | 1.18 |
| 22.78 | 3.55 |
| 29.41 | 5.92 |
| 34.80 | 8.29 |
| 39.46 | 10.66 |
| 43.63 | 13.03 |
| 47.43 | 15.39 |
| 50.95 | 17.76 |
| 54.24 | 20.13 |
| 57.34 | 22.50 |
| 60.28 | 24.87 |

Assuming a “linear” relationship is a strong assumption and will not fit all cases for implementation of the material dispensing system 10. In limited cases, assuming a “linear” relationship might provide “good enough” data for control of the material dispensing system 10. On the other hand, assuming a “non-linear” relationship is a weaker assumption and can accommodate a wide range of systems and processes associated with implementation of the material dispensing system 10 including those that happen to be linear or nearly so. Accordingly, the disclosed process for implementation in the material dispensing system 10 may be more universally applicable.

FIG. 5 illustrates an exemplary calibration process according to the disclosure.

In particular, FIG. 5 illustrates a calibration process 500 for implementation by the material dispensing system 10. In particular, the calibration process 500 may be implemented by the controller 100 and/or the user interface 24 and may be utilized in conjunction with implementation of the material dispensing system closed loop process 600. In particular, in aspects the calibration process 500 may be utilized to generate a non-linear runup to get the material dispensing system 10 as close as possible to a desired operation and then the material dispensing system closed loop process 600 may be implemented to fine tune the material dispensing system 10. In aspects, the material dispensing system 10 may be operated with the material dispensing system closed loop process 600 and without the calibration process 500. In this regard, operation of the material dispensing system 10 utilizing the closed loop implementations of the material dispensing system closed loop process 600 may not require implementation of the calibration process 500.

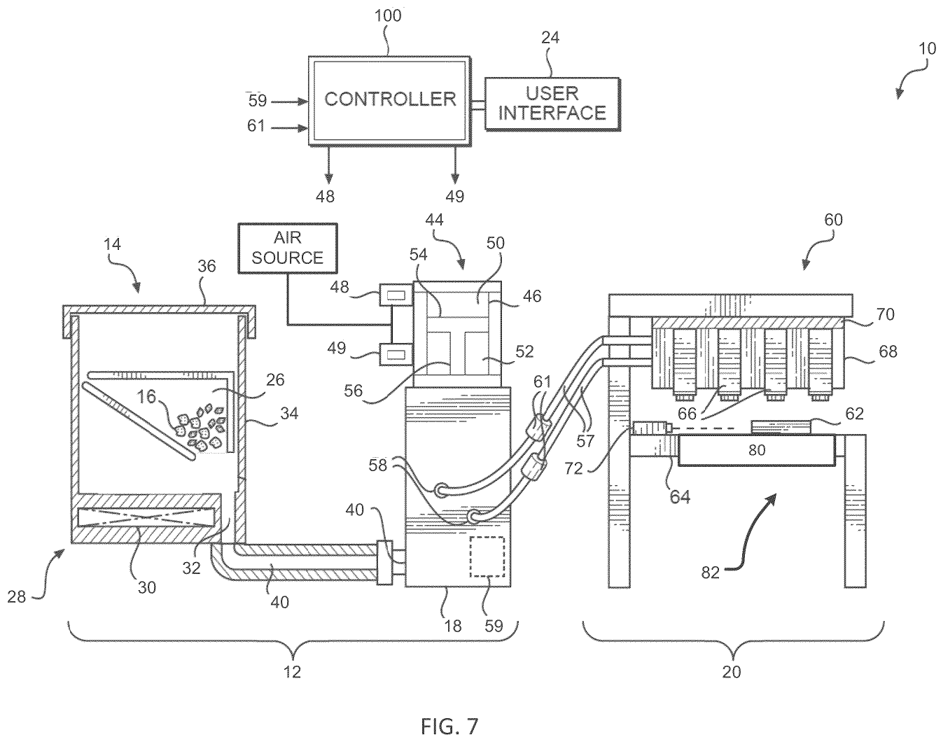

Initially, the calibration process 500 may include operating the material dispensing system 10 at an intended application temperature for a chosen material 502. In this regard, the controller 100 and/or the user interface 24 may allow for a controlled operation of the material dispensing system 10 at an intended application temperature of the material 16 as described in the implementation of the material dispensing system 10 described in conjunction with FIG. 7.

Thereafter, the calibration process 500 may include operating the material dispensing system 10 at different line speeds and, for each line speed, a pressure may be adjusted by the controller 100 and/or the user interface 24 to achieve a flow rate that is proportional to the line speed 504. In aspects, the calibration process 500 may include operating the material dispensing system 10 at 3 different line speeds, 4 different line speeds, 5 different line speeds, 6 different line speeds, 7 different line speeds, 8 different line speeds, 9 different line speeds, 10 different line speeds, 11 different line speeds, and/or 12 different line speeds. In aspects, the calibration process 500 may include operating the material dispensing system 10 at 3-12 different line speeds, 3-4 different line speeds, 3-5 different line speeds, 3-6 different line speeds, 3-7 different line speeds, 3-8 different line speeds, 3-9 different line speeds, 3-10 different line speeds, 3-11 different line speeds, and/or 3-12 different line speeds. In aspects, the calibration process 500 may include operating the material dispensing system 10 at more than 2 different line speeds. Since the material dispensing system 10 can measure the output of the material 16 with the flow sensors 61, the material dispensing system 10 may be automated by aspects of the disclosure such as implementation of the material dispensing system closed loop process 600 for further utility and/or convenience. Since the material dispensing system 10 can measure the output of the material 16 with the flow sensors 61, the material dispensing system 10 may be automated by aspects of the disclosure such as implementation of the material dispensing system closed loop process 600 for further utility and/or convenience. In this regard, the controller 100 and/or the user interface 24 may allow for a controlled operation of the material dispensing system 10 at different line speeds for the conveyor 80, the dispense line 82, and/or the like. Moreover, the controller 100 and/or the user interface 24 may allow for a controlled operation of the pump 44 at different pressures to achieve a desired pressure of the material 16 to achieve a flow rate for application of the material 16 to the one or more substrates 62 that achieves a desired and consistent amount of the material 16 applied to the one or more substrates 62.

In particular, this process may control a pressure Pn of the material 16 controlled by the pump 44 for a line speed LSn of the conveyor 80 and/or the dispense line 82 to obtain a flowrate Qn of the material 16 applied to the one or more substrates 62 and/or a flow rate expressed as an add-on for discrete products QAn of the material 16 applied to the one or more substrates 62 that achieves a desired and consistent amount of the material 16 applied to the one or more substrates 62. Each of the different line speeds of the conveyor 80 and/or the dispense line 82 and pressures of the material 16 and/or the pump 44 may be recorded and/or stored for further processing in conjunction with the calibration process 500.

In this regard, the material dispensing system 10 may be operated with a first line speed (LS1) by the conveyor 80 and/or the dispense line 82 responsive to the controller 100 and/or the user interface 24 and a first pressure (P1) may be adjusted by the pump 44 responsive to the controller 100 and/or the user interface 24 to achieve a first flow rate (Q1) that is proportional to the first line speed (LS1) that achieves a desired and consistent amount of the material 16 applied to the one or more substrates 62. For example, Go to LS1=10; and adjust pressure P1 so flowrate Q1=Q or (add-on) is QA.

Thereafter, the material dispensing system 10 may be operated with a second line speed (LS2) by the conveyor 80 and/or the dispense line 82 responsive to the controller 100 and/or the user interface 24 and a second pressure (P2) may be adjusted by the pump 44 responsive to the controller 100 and/or the user interface 24 to achieve a second flow rate (Q2) that is proportional to second line speed (LS2) that achieves a desired and consistent amount of the material 16 applied to the one or more substrates 62. For example, Go to LS2=30; and adjust pressure P2 so flowrate Q2=3Q or (add-on) is QA.

Finally, the material dispensing system 10 may be operated with a third line speed (LS3) by the conveyor 80 and/or the dispense line 82 responsive to the controller 100 and/or the user interface 24 and a third pressure (P3) is adjusted by the pump 44 responsive to the controller 100 and/or the user interface 24 to achieve a third flow rate (Q3) that is proportional to third first line speed (LS3) that achieves a desired and consistent amount of the material 16 applied to the one or more substrates 62. For example, Go to LS3=50; and adjust pressure P3 so flowrate Q3=5Q or (add-on) is QA. However, it should be noted that the calibration process 500 may be implemented with n different line speeds, pressures, and flow rates that achieve a desired and consistent amount of the material 16 applied to the one or more substrates 62. In aspects, n may be greater than or equal to 3. In aspects, n may be 3, 4, 5, 6, 7, 8, 9, 10, 11, or 12.

Accordingly, the calibration process 500 operates the conveyor 80 and/or the dispense line 82 responsive to the controller 100 and/or the user interface 24 at different speeds and the pump 44 responsive to the controller 100 and/or the user interface 24 is operated at different pressures to ascertain a flow rate that achieves a desired and consistent amount of the material 16 applied to the one or more substrates 62 irrespective of a speed of the conveyor 80 and/or the dispense line 82.

Thereafter, the calibration process 500 may generate a non-linear control algorithm for operational parameters for operation of the system 506. In particular, the calibration process 500 utilizes the different speeds of the conveyor 80 and/or the dispense line 82 together with the determined pressures to model and/or generate a control algorithm that achieves a desired and consistent amount of the material 16 applied to the one or more substrates 62 irrespective of a speed of the conveyor 80 and/or the dispense line 82. More specifically, the calibration process 500 utilizes the different speeds of the conveyor 80 and/or the dispense line 82 together with the determined pressures to model and/or generate constants to be used in a non-linear control algorithm that achieves a desired and consistent amount of the material 16 applied to the one or more substrates 62 irrespective of a speed of the conveyor 80 and/or the dispense line 82. Additionally or alternatively, this aspect of the calibration process 500 may utilize machine learning, artificial intelligence, and/or the like.

Finally, the calibration process 500 may include operating the material dispensing system 10 with the non-linear control algorithm 508. In particular, the algorithm created through the calibration process 500 may be utilized by the material dispensing system 10 for subsequent operation to ensure the material dispensing system 10 applies a desired and consistent amount of the material 16 to the one or more substrates 62 irrespective of a speed of the conveyor 80 and/or the dispense line 82.

In this regard, the controller 100 is configured to generate the non-linear control algorithm during operation of the material dispensing system 10 at a plurality of line speeds by receiving for each of the plurality of line speeds of the conveyor 80 an associated operational pressure of the material 16 by the controller 100 and/or the user interface 24 that provides a desired amount of the material applied to the substrates 62. Moreover, the material dispensing system 10 and/or the controller 100 may be configured to associate and store each of the plurality of line speeds of the conveyor 80 and the associated operational pressure the material 16.

Additionally, the material dispensing system 10 may implement the user interface 24 to receive the desired speed of the conveyor 80. Moreover, the controller 100 may receive the desired speed from the user interface 24 to control the speed of the conveyor 80. Furthermore, the controller 100 and/or the calibration process 500 may determine the target pressure of the material 16 provided by the pump 44 to the one or more application devices 60 based on the desired speed received in the user interface 24 to provide the desired amount of the material to each of the substrates 62 utilizing the non-linear control algorithm generated by the calibration process 500.

In this regard, it is noted that the calibration procedure implemented as the calibration process 500 is simple and easy to understand. At each point in implementation of the calibration process 500, the action is the same and makes sense to achieve “add-on matching” or “flowrate-proportioning.” In aspects, the material dispensing system 10 may implement a piston pump system where an air pressure is controlled by the material dispensing system 10 to vary hydraulic pressure.

The calibration process 500 may be utilized in a number of different ways. In one aspect, the calibration process 500 may be implemented using three points over a dispensing range (excluding zero flow conditions like line speed=0). Further, the calibration process 500 may be implemented to fit a curve to the three points where the flow, Q, is proportional to a line speed. Equivalently, if “add-on” (dispense amount per product) is the criteria, then add-on should be the same at each line speed.

In aspects, implementation of the calibration process 500 may result in three equations with three unknowns (constants A, B, C):

$$P 0 = A ⋆ SQRT ( LS 0 ) + B ⋆ LS 0 + C$$

$$P 1 = A ⋆ SQRT ( LS 1 ) + B ⋆ LS 1 + C$$

$$P 2 = A ⋆ SQRT ( LS 2 ) + B ⋆ LS 2 + C$$

where:
LS=line speed;
P=pressure; and
Constants A, B, C may determine the shape of the pressure vs. line speed relationship (curve).

In aspects, the calibration process 500 may implement an algorithm utilizing a matrix to determine the constants. Accordingly, the solution is X=M⁻¹*P.

where:

$$Pressures P = [ \begin{matrix}P 0 \\ P 1 \\ P 2\end{matrix} ] ;$$

$$Constrants defining the curve X = [ \begin{matrix}A \\ B \\ C\end{matrix} ] ; and$$

$$A Matrix of line speeds M = [ \begin{matrix}SQRT ( LS 0 ) & LS 0 & 1 \\ SQRT ( LS 1 ) & LS 1 & 1 \\ SQRT ( LS 2 ) & LS 2 & 1\end{matrix} ] .$$

The resulting matrix to determine the constants may be represented as:

$$[ \begin{matrix}A \\ B \\ C\end{matrix} ] = [ \begin{matrix}SQRT ( LS 0 ) & LS 0 & 1 \\ SQRT ( LS 1 ) & LS 1 & 1 \\ SQRT ( LS 2 ) & LS 2 & 1\end{matrix} ] ⋆ [ \begin{matrix}P 0 \\ P 1 \\ P 2\end{matrix} ]$$

The controller 100 may implement the calibration process 500 to solve for the Constants A, B, C. Thereafter, the material dispensing system 10 may operate in conjunction with the controller 100 to implement the algorithm to operate the conveyor 80 and/or the dispense line 82 of the material dispensing system 10 with any line speed and the controller 100 may calculate the appropriate pressure of the material 16 for a consistent application amount of the material 16 to the one or more substrates 62. Since the matrix is small, these calculations can also be performed discretely by the controller 100 and/or another computer without a matrix math software library. However, the controller 100 and/or another computer may operate with a matrix math software library. In aspects, the controller 100 and/or another computer may operate with a matrix math software library that may be utilized in implementations where n is greater than 3.

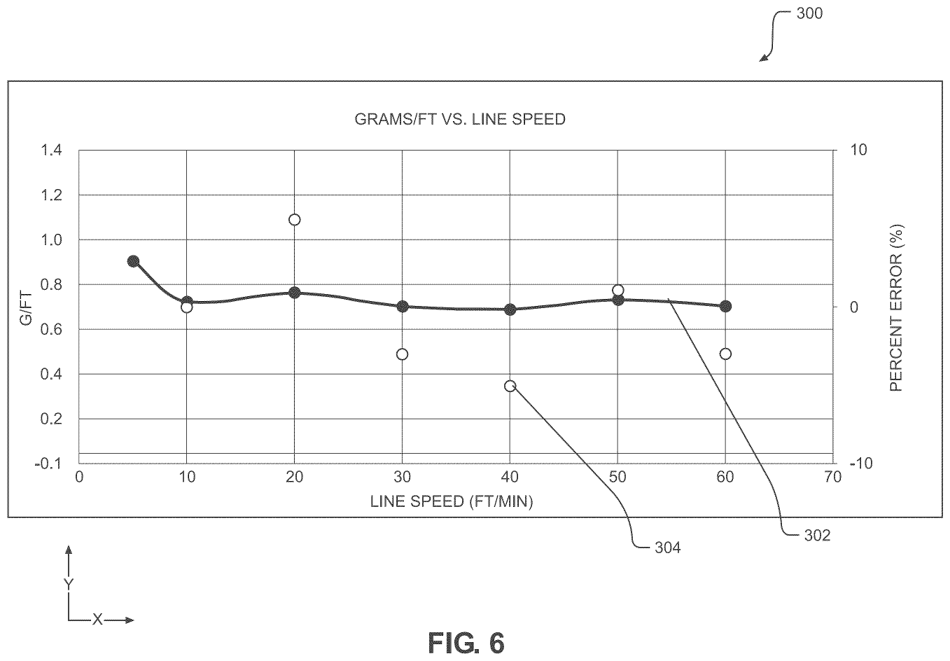

FIG. 6 illustrates exemplary graph results of an application of material by the material dispensing system after a calibration process according to the disclosure.

In particular, FIG. 6 illustrates exemplary graph results of an application of the material 16 by the material dispensing system 10 and/or the controller 100 after implementation of the calibration process 500. In this regard, FIG. 6 illustrates graph results 300 of an application of the material 16 to the one or more substrates 62 by the material dispensing system 10 having units of grams of dispensed material per foot (g/ft) along the vertical axis or y-axis versus a line speed having units of feet per minute (ft/min) along the horizontal axis or X axis. In this regard, a line 302 and associated data points illustrate that as the line speed of the conveyor 80 and/or the dispense line 82 of the material dispensing system 10 increases or decreases along the X axis, the amount of the application of the material 16 to the one or more substrates 62 by the material dispensing system 10 responsive to the controller 100 implementing the calibration process 500 remains substantially the same. In this regard, the line 302 should be generally flat or as flat possible; and additionally note the graph results 300 illustrated in FIG. 6 include noisy/non-structured measurement error data points 304 which indicate a percent error of less than 10%.

The disclosed system and process implementation of the material dispensing system 10 and/or the calibration process 500 provides excellent accuracy of application of the material 16 to the one or more substrates 62. Moreover, the disclosed system and process implementation in the material dispensing system 10 is relatively simple. The disclosed process and system implementation of the material dispensing system 10 and/or the calibration process 500 adapts to various combinations of hoses, nozzle sizes, and/or the like of the material dispensing system 10 by modeling, characterizing, and/or the like the pressure vs. flow relationship in the material dispensing system 10 utilizing the calibration process 500.

The disclosed process and device implementation accommodates both linear and non-linear system implementations of the material dispensing system 10, making few assumptions. The disclosed process and system implementation of the material dispensing system 10 and/or the calibration process 500 extrapolates well outside the range of calibration.

The disclosed process and system implementation of the material dispensing system 10 and/or the calibration process 500 takes into account various materials, adhesives, application conditions such as temperature, and/or the like.

The disclosed process and system implementation of the material dispensing system 10 and/or the calibration process 500 enables the manufacture of good products over a wide range of line speeds, including ramp up and ramp down. This can reduce waste of both the material 16 and the one or more substrates 62. The disclosed process and system implementation of the material dispensing system 10 can also match production rate to upstream and downstream production processes.

The disclosed system and process has been implemented and found to work well as shown in the graph illustrated in FIG. 6. Nevertheless, various alternate embodiments are possible. Additionally, the disclosed system and process implementing the calibration process 500 may approximate the curve with a second order or higher polynomial.

The disclosed system and process may utilize more than three points and implement a “least squares” fit as part of the calibration process 500. This can reduce inaccuracy due to measurement noise. The disclosed system and process may use a formulation based on other types of curve fit for implementation of the calibration process 500. The disclosed system and process may be implemented in conjunction with the calibration process 500 with or without a matrix math software library.

Accordingly, the material dispensing system 10 is configured to implement the non-linear algorithm to offset the non-linear nature of the material dispensing system 10 in order to provide a flow rate of the material 16 that scales linearly with line speed of the conveyor 80. This will provide a proper amount of the material 16, a more consistent amount of the material 16, a greater consistency of an amount of the material 16, and/or the like on each of the substrate 62 or the product relatively independent of line speed of the conveyor 80. Additionally, the material dispensing system 10 may use sensors and controls to control adhesive consumption in conjunction with the calibration process 500. The material dispensing system 10 may be configured to apply a consistent amount of adhesive (e.g., “add-on” weight or volume) to the substrate(s) by implementation of the calibration process 500. The material dispensing system 10 may be configured to receive a target adhesive applied per substrate and implementation of the calibration process 500 may continuously control components of the material dispensing system 10 accordingly. Therefore, the material dispensing system 10 may ensure sufficient adhesive is applied through application of the calibration process 500, while increasing the economics and aesthetics of adhesive application by reducing waste.

It will be appreciated that the material dispensing system 10 shown and described herein is merely exemplary, and that the control of the amount of adhesive applied per substrate is applicable to other hot melt adhesive systems. For example, the material dispensing system 10 may include a separated hopper and melter, but could also be a hot melt adhesive system that includes a grid and reservoir melter.

The material dispensing system 10 may apply a material, such as an adhesive, to any type of substrate, such as packaging, electronics, hygienic, industrial, consumer goods, and/or paper products. For example, the packaging may include boxes, envelopes, and/or the like; and the electronics may include semi-conductors, circuit boards, and/or the like. Furthermore, although discussed with regard to adhesives, the material dispensing system 10 may also be configured to apply a number of other materials, such as food products.

FIG. 7 illustrates a diagrammatic view of an exemplary material dispensing system.

Referring to FIG. 7, the dispensing unit 12 may further include a manifold 18 connected to the material supply 14. In aspects, the material supply 14 may be configured as an adhesive material supply and the material 16 may be an adhesive material. Accordingly, the material supply 14 may be configured to receive and melt solid or semi-solid hot melt adhesive material.

The material supply 14 may include a hopper 26 configured to contain the material 16 when in the solid or semi-solid state, and a melter 28 having a heating element 30 and a reservoir 32, such that the heating element 30 may be configured to melt the material 16 when contained in the reservoir 32. In other implementations, the material supply 14 may not include the heating element 30, which may instead be in the manifold 18. The material supply 14 may also include one or more side walls 34 and a removable cover 36 configured to contain the hopper 26. The reservoir 32 may be coupled to a rigid or flexible flow path 40 that enables passage of the material 16 to the manifold 18. The rigid or flexible flow path 40 may have minimal or near zero length.

The manifold 18 may be mounted to the side wall 34 of the material supply 14 and may be coupled to the pump 44. The pump 44 may be configured to pump the material 16 from the material supply 14 and into the manifold 18 where the material 16 may be split into separate flows.

In some aspects, the pump 44 may include a housing 46 defining a piston chamber that receives a piston 54. A pump rod 56 may extend downwardly from the piston 54 into the manifold 18 to pressurize the material 16. The piston 54 may divide the piston chamber into an upper chamber 50 and a lower chamber 52. The upper chamber 50 may selectively receive pressurized air from a first actuator 48, and the lower chamber 52 may selectively receive pressurized air from the second actuator 49. Therefore, the first actuator 48 and the second actuator 49 may be alternatively actuated to provide pressurized air in the upper chamber 50 to push on an upper side of the piston 54 to move the piston 54 and pump rod 56 in one direction, and then to provide pressurized air in the lower chamber 52 to push on a lower side of the piston 54 to move the piston 54 and the pump rod 56 in another direction. This reciprocating movement of the pump rod 56 may repeatedly draw the material 16 into the manifold 18 from the material supply 14 and expel the material 16 out of the manifold 18. The piston 54 and/or the pump rod 56 may include one or more sensors (not shown) to determine material flow rate. The first actuator 48 and the second actuator 49 may include solenoids, spool valves, and/or any other type of actuator configured to provide the pressurized air. Accordingly, the pump 44 may be controlled by a pressure level of the pressurized air provided to the pump 44 by the first actuator 48 and the second actuator 49 received from an air source as illustrated in FIG. 7.

In some aspects, the pump 44 may, alternatively, be actuated by one or more magnetic shifters. Although described as a piston pump, the pump 44 may embody any type of pump including an air piston pump and/or the like.

In aspects, the pump 44 may include or may be coupled to a device to control that hydraulic output pressure of the material 16. In some aspects, the pump 44 may include or may be coupled to an air-piloted voltage-to-pressure or current-to-pressure device to control air pressure to the pump 44, such that hydraulic output pressure may be proportional to input air pressure. In some aspects, the pump 44 may include a pressure control valve in a re-circulation path parallel to the output path, such that the pressure control valve may be modulated with either air or electrically. In some aspects, a pressure reducing regulator may be directly in line with the output flow path providing a substantially constant pressure source. In aspects, the substantially constant pressure source may only be substantially constant at one line speed. In aspects, the pressure reducing regulator may smooth out many variations of the material dispensing system 10. In aspects, the pressure reducing regulator may be air controlled. In this regard, as the air pressure is varied to the pressure reducing regulator, then the pressure also varies. In aspects, an air to glue pressure ratio of the pump 44 may be greater than the air to glue pressure of the pressure reducing regulator. As a nonlimiting example, an air to glue pressure ratio of the pump 44 may typically be 14:1 while the air to glue pressure of the pressure reducing regulator may be lower at, for example, 10:1. As a further nonlimiting example, at a 50 PSI air pressure, the pump produces 700 PSI while the regulator provides 500 PSI. The “headroom” (200 PSI in this example) provides a difference for the regulator to operate. The disclosed process and system is configured to operate with implementations of the material dispensing system 10 that do not implement a pressure reducing regulator as well as implementations of the material dispensing system 10 that do implement a pressure reducing regulator, which is an advantage of the disclosed system and process.

The manifold 18 may include one or more ports 58 that create flow streams of the material 16. The manifold 18 may also include a flow sensor 59 for measuring the flow rate of the material 16 therethrough. The flow sensor 59 may generate a signal indicative of flow rate information. For example, the flow sensor 59 may be an encoder that measures the rotation of a shaft in the manifold 18 that a flow of the material 16 causes to rotate. The flow sensor 59 may, additionally or alternatively, be at an outlet of the manifold 18, and the flow sensor 59 may include a plurality of ports for attachment to the hoses 57. Exemplary manifolds including a flow sensor suitable for the present are disclosed in U.S. Pat. No. 6,857,441 and U.S. Provisional Patent App. No. 62/318,114 filed Apr. 4, 2016, the disclosures of which are incorporated by reference herein. Other manifolds, flow sensors, or flow rate measuring devices, may be used, and the specific form of the manifold 18 and the flow sensor 59 discussed herein provide an exemplary illustration only. In addition, a pressure sensor may also be used in place of or in conjunction with the flow sensor 59. The flow sensor 59 is part of a control system associated with the pump 44, as will be discussed.

The one or more ports 58 of the manifold 18 may be fitted with hoses 57 connected to the application unit 20. The hoses 57 may be fitted with the one or more flow sensors 61 configured to generate a signal based on flow rate information. The flow sensors 61 may be positioned in-line with the hoses 57. For example, the material dispensing system 10 may include a plurality of small implementations of the flow sensors 61 in-line with each of the hoses 57. In some aspects, the flow sensors 61 may include a rotary encoder positioned inside of the hoses 57 and may be configured to generate a signal based on the rate of fluid flow of the material 16. In some aspects, the flow sensors 61 may be positioned outside the hoses 57 (e.g., as depicted in FIG. 7) and configured to measure flow rate through laser-based interferometry and/or the Doppler-based measurements and generate a signal.

The application devices 60 may include one or more adhesive dispensing modules 66 mounted to application device bodies 68 having application device heaters 70 on the support 64. The adhesive dispensing modules 66 of the application devices 60 may provide a nozzle through which the material 16 is dispensed. In some aspects, one or more flow sensor(s) may be positioned in and/or on the application devices 60 and configured to generate a signal based on flow rate information of the applied portions of the material 16. For example, the flow sensor(s) of the application devices 60 may be configured to detect the flow rate of the material 16 into the application devices 60, through the application devices 60, and/or out of the nozzle(s), and/or the size of the nozzle(s). The flow sensor(s) may be positioned at an inlet of the application devices 60 and/or at each of the nozzle(s) depending on the desired precision.

The application unit 20 may include one or more substrate sensors 72 configured to detect the substrates 62 including a number of the substrates 62 that are conveyed on the conveyor 80 and/or applied with the material 16. In some aspects, the substrate sensor 72 may be implemented as an optical sensor configured to detect a break in an optical beam induced by the passage of the substrate 62. It is also contemplated that the substrate sensor 72 may include a weight sensor configured to detect passage of the substrate 62 based on the weight applied to the substrate sensor 72.

Although the material dispensing system 10 is depicted in FIG. 7 as including a single application unit located adjacent a single implementation of the dispensing unit 12, different numbers of implementations of the dispensing unit 12, the application units 20, the application devices 60, the support 64, the conveyor 80, and/or the like may be used in any configuration.

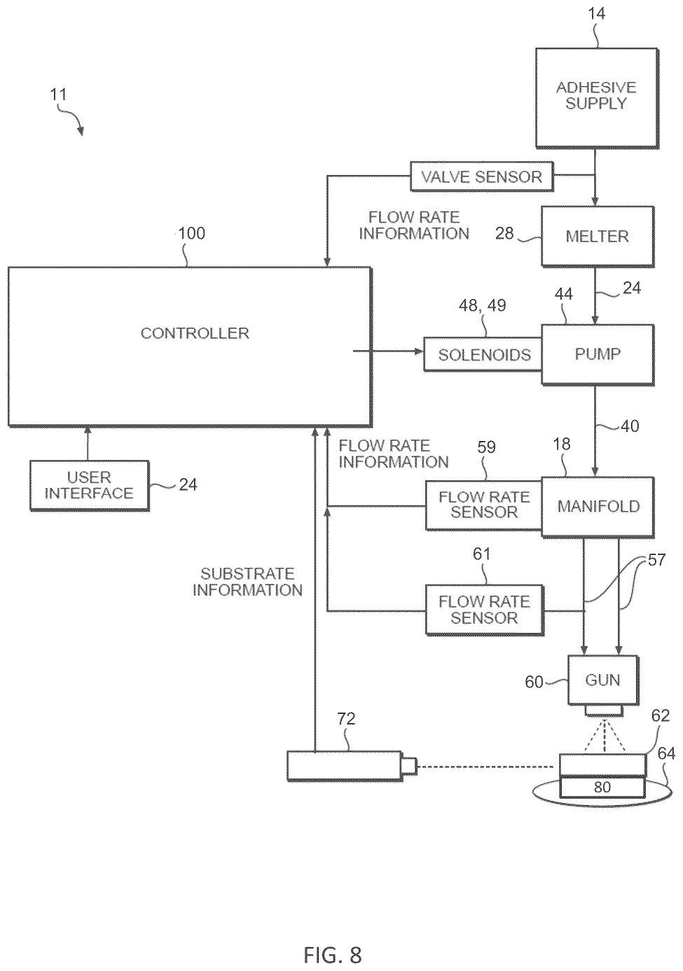

FIG. 8 illustrates an exemplary schematic view of a control system according to the disclosure.

FIG. 8 illustrates an exemplary schematic view of a control system 11 that may be implemented in the exemplary implementation of the material dispensing system 10 of FIG. 7. The control system 11 may include one or more of the controllers 100 in communication with one or more sensors and/or actuators. For example, the controller 100 may be in wired and/or wireless communication with the user interface 24, the first actuator 48, the second actuator 49, the one or more of the flow sensors 59, 61, the substrate sensor 72, the conveyor 80, and/or the like. The controller 100 may include one or more computers, servers, modules, and/or programmable circuits that receives the various sensor inputs and produces a control signal, for example, to control the pump 44 through the first actuator 48 and the second actuator 49. The controller 100 may also be configured to receive target application settings of the material 16 (e.g., through user interface 24) or store preset application settings of the material 16 and control the pump 44. For example, the controller 100 may be configured to receive a target amount of the material 16 applied to each substrate 62. The controller 100 may be realized in many different forms and configurations, including but not limited to a programmable microcontroller, a Programmable Logic Controller (PLC), discrete circuit components, Application-Specific Integrated Circuit (ASIC) type controllers, and/or the like to execute an appropriate control algorithm, for example a closed loop Proportional-Integral-Derivative (PID) controller control method.

The controller 100 may receive flow rate information from one or more of the sensors. For example, in some aspects, the control system 11 may include the flow sensor 59 for measuring the flow rate of the material 16 through the manifold 18. The control system 11 may, additionally or alternatively, include other sensors to detect flow rate information, which may be processed to determine the flow of the material 16 into the melter 28. The control system 11 may include the flow sensor 61 configured to detect the flow of the material 16 through one or more of the hoses 57 to the application devices 60. The control system 11 may further include the flow sensor operatively connected to the application devices 60 and configured to detect the material 16 flowing from the application devices 60 onto one or more substrates 62. The detected flow rate information of the material 16 may include flow rate, pressure, temperature, viscosity, and/or the like. The flow sensor operatively connected to the application devices 60 may further detect nozzle size of the application devices 60 such as guns, glue guns, adhesive guns, and/or the like. The flow rate information may be received and processed by the controller 100 in order to execute control signals.

The controller 100 may also receive substrate information from the substrate sensor 72. The substrate sensor 72 may be configured to detect the substrates 62 that pass through the support 64, for example, by way of the conveyor 80. The substrate information may include the number, the size, and/or the type of the substrate 62 and may be used to determine the amount of the material 16 applied to reach the target adhesive per substrate. For example, the more substrates 62 passing through the support 64 may require more of the material 16 to be applied. Furthermore, the larger substrates 62 may require additional portions of the material 16. The substrate sensor 72 may be positioned and/or configured to detect application areas of the substrates 62. For example, if the material dispensing system 10 is intended to apply the material 16 to a seam of the substrate (such as a box), the substrate sensor 72 may be configured to measure the length of the seam to determine the amount of adhesive material that needs to be applied to the seam. The substrate sensor 72 may generate a signal to the controller 100 indicative of the substrate information.

The controller 100 may also generate control signals to the first actuator 48 and the second actuator 49 associated with the pump 44. The controller 100 may hydraulically, mechanically, magnetically and/or electrically change the operating state of the first actuator 48 and the second actuator 49, which controls the rate at which the pump 44 advances the material 16 through the material dispensing system 10.

The controller 100 may be configured to perform machine control and includes features for starting, stopping, controlling, and/or the like aspects of pumping in the material dispensing system 10. Particularly, the controller 100 may receive and/or generate various control information, such as target information relating to a target adhesive per substrate for the control system 11. For example, the adhesive applied per substrate may depend on a number of aspects of the flow rate information (e.g., flow rate, pressure, temperature, and/or viscosity of the material 16) and the substrate information (e.g., quantity and size of the substrates 62). Accordingly, the controller 100 may detect each of these aspects through the sensors and determine how the aspects affect the adhesive per substrate 62. The controller 100 may compare the information of the actual flow rate to the targeted adhesive per substrate 62. In response, the controller 100 may send control signals to control the first actuator 48 and the second actuator 49 to operate at a pump speed associated with the target adhesive applied per substrate.

The controller 100 may also be associated with the user interface 24 for providing a user with information about, and control over, pumping functions of the material dispensing system 10. The user interface 24 may present information to the user relating to adhesive flow rate, motor speed, and other pumping-related parameters of the material dispensing system 10. The user interface 24 may provide controls for the user to adjust pumping-related parameters of the material dispensing system 10. In some aspects, the user interface 24 may be configured to receive the target adhesive applied per substrate 62 or other control information from the user. For example, the user interface 24 may receive a target of one gram of the material 16 applied per substrate 62. The user interface 24 may then generate a signal to the controller 100, where it is processed to control and/or determine the required speed of the material 16 and corresponding pressure of the pump 44. The controller 100 may also factor in flow rate information (e.g., pressure, temperature, viscosity, and/or nozzle size) and substrate information (e.g., the speed of the conveyor 80 of the support 64 to determine the exposure of the substrates 62 to the material 16). The controller 100 may then generate control signals to the first actuator 48 and the second actuator 49 to control the pump 44.

In addition to receiving the measured flow rate information from the flow sensors 59, 61 and the controller 100 may be configured to compare the measured flow rate information with the control information. In response to this comparison, the controller 100 may generate and implement motor control instructions or otherwise controls or adjusts the first actuator 48 and the second actuator 49, such as by controlling the frequency or voltage of the electrical power supplied thereto. In turn, the pump 44 may be controlled or adjusted so as to cause a flow rate of the material 16 (e.g., as measured by one of the flow sensor 59, 61) that corresponds to the target adhesive applied per substrate 62 associated with the control instructions. By continuously measuring the flow rate of the material 16 and by continuously adjusting the pump 44 (through the first actuator 48 and the second actuator 49) in view of the measured flow rate information, a closed-loop adhesive flow rate feedback system is provided.

Exemplary pumps for the disclosure are disclosed in U.S. Pat. No. 7,381,035 filed Feb. 11, 2005, assigned to Nordson Corporation; U.S. Pat. No. 6,155,806 filed Dec. 16, 1998, assigned to Nordson Corporation; and U.S. Pat. No. 5,325,762 filed Jul. 26, 1993, assigned to Nordson Corporation, the disclosures of which are incorporated by reference herein.

Exemplary components for the disclosure are disclosed in U.S. Pat. No. 5,054,650 filed Mar. 8, 1990, assigned to Nordson Corporation; U.S. Pat. No. 4,988,15 filed Mar. 8, 1990, assigned to Nordson Corporation; and U.S. Pat. No. 4,987,854 filed Dec. 12, 1988, assigned to Nordson Corporation, the disclosures of which are incorporated by reference herein.

The following are a number of nonlimiting EXAMPLES of aspects of the disclosure. One EXAMPLE includes: EXAMPLE 1. A method for controlling material application in a material dispensing system, the method includes: implementing a conveyor configured to convey substrates along a dispense line at a speed; implementing an application device configured to apply a desired amount of a material to each of the substrates; implementing a pump configured to deliver the material at a pressure to the application device; implementing a controller configured to receive a desired speed of the conveyor and control a speed of the conveyor to convey the substrates along the dispense line at the desired speed; determining with the controller a target pressure of the material provided by the pump to the application device to provide the desired amount of the material to each of the substrates utilizing a control algorithm, measuring an amount of material applied to a plurality of substrates by a pump; comparing the material applied per substrate to a target value; and adjusting a pressure of the pump based on the comparing the material applied per substrate to a target value.

The above-noted EXAMPLE may further include any one or a combination of more than one of the following EXAMPLES: 2. The method for controlling material application in a material dispensing system of any EXAMPLE herein, where the control algorithm is configured to account for a non-linear relationship between the pressure of the material and the speed of the conveyor. 3. The method for controlling material application in a material dispensing system of any EXAMPLE herein, where the control algorithm is configured to account for a non-linear relationship of flow resistance of components of the material dispensing system for determining the pressure of the material and the speed of the conveyor. 4. The method for controlling material application in a material dispensing system of any EXAMPLE herein, where the controller determines the target pressure of the material provided by the pump to the application device based on the desired speed to provide the desired amount of the material to each of the substrates utilizing a non-linear control algorithm. 5. The method for controlling material application in a material dispensing system of any EXAMPLE herein, where the controller receives the desired speed to control the speed of the conveyor; and where the controller determines the target pressure of the material provided by the pump to the application device based on the desired speed to provide the desired amount of the material to each of the substrates utilizing a non-linear control algorithm. 6. The method for controlling material application in a material dispensing system of any EXAMPLE herein, includes generating with the controller the control algorithm during operation of the material dispensing system at a plurality of line speeds by receiving for each of the plurality of line speeds of the conveyor an associated operational pressure of the material by the controller and/or a user interface that provides a desired amount of the material applied to the substrates. 7. The method for controlling material application in a material dispensing system of any EXAMPLE herein, includes associating and storing with the controller each of the plurality of line speeds of the conveyor and the associated operational pressure the material. 8. The method for controlling material application in a material dispensing system of any EXAMPLE herein, where the generating with the controller the control algorithm includes generating an algorithm based on the plurality of line speeds of the conveyor and the associated operational pressure of the material with the controller to generate a pressure of the material for the desired amount of the material applied to the substrates at any speed of the conveyor for subsequent operation of the material dispensing system. 9. The method for controlling material application in a material dispensing system of any EXAMPLE herein, where the conveyor is configured to convey the substrates along the dispense line at variable speeds and/or one of multiple speeds. 10. The method for controlling material application in a material dispensing system of any EXAMPLE herein, where the material includes an adhesive.

One EXAMPLE includes: EXAMPLE 11. A material dispensing system, the material dispensing system includes: a conveyor configured to convey substrates along a dispense line at a speed; an application device configured to apply a desired amount of a material to each of the substrates; a pump configured to deliver the material at a pressure to the application device; a controller configured to receive a desired speed of the conveyor and control a speed of the conveyor to convey the substrates along the dispense line at the desired speed; the controller configured to determine a target pressure of the material provided by the pump to the application device to provide the desired amount of the material to each of the substrates utilizing a control algorithm; a flow sensor configured to measure an amount of material applied to a plurality of substrates by a pump; the controller configured to compare the material applied per substrate to a target value to generate a comparison value; and the controller configured to adjust a pressure of the pump based on the comparison value.

The above-noted EXAMPLE may further include any one or a combination of more than one of the following EXAMPLES: 12. The material dispensing system of any EXAMPLE herein, where the control algorithm is configured to account for a non-linear relationship between the pressure of the material and the speed of the conveyor. 13. The material dispensing system of any EXAMPLE herein, where the control algorithm is configured to account for a non-linear relationship of flow resistance of components of the material dispensing system for determining the pressure of the material and the speed of the conveyor. 14. The material dispensing system of any EXAMPLE herein, where the controller determines the target pressure of the material provided by the pump to the application device to provide the desired amount of the material to each of the substrates utilizing a non-linear control algorithm. 15. The material dispensing system of any EXAMPLE herein, where the controller determines the target pressure of the material provided by the pump to the application device based on the desired speed to provide the desired amount of the material to each of the substrates utilizing a non-linear control algorithm. 16. The material dispensing system of any EXAMPLE herein, includes generating with the controller the control algorithm during operation of the material dispensing system at a plurality of line speeds by receiving for each of the plurality of line speeds of the conveyor an associated operational pressure of the material by the controller and/or a user interface that provides a desired amount of the material applied to the substrates. 17. The material dispensing system of any EXAMPLE herein, includes associating and storing with the controller each of the plurality of line speeds of the conveyor and the associated operational pressure the material. 18. The material dispensing system of any EXAMPLE herein, where the generating with the controller the control algorithm includes generating an algorithm based on the plurality of line speeds of the conveyor and the associated operational pressure of the material with the controller to generate a pressure of the material for the desired amount of the material applied to the substrates at any speed of the conveyor for subsequent operation of the material dispensing system. 19. The material dispensing system of any EXAMPLE herein, where the conveyor is configured to convey the substrates along the dispense line at variable speeds and/or one of multiple speeds. 20. The material dispensing system of any EXAMPLE herein, where the material includes an adhesive.

Computer programs based on the written description and methods of this specification including the calibration process 500 are within the skill of a software developer. The various programs or program modules including the calibration process 500 can be created using a variety of programming techniques. For example, program sections or program modules can be designed in or by means of Java, C, C++, assembly language, or any such programming languages. One or more of such software sections or modules can be integrated into a computer system, non-transitory computer-readable media, or existing communications software. The computer programs including the calibration process 500 may be read and executed by a processor of the controller 100.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The disclosure may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

Further in accordance with various aspects of the disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

The artificial intelligence and/or machine learning may utilize any number of approaches including one or more of cybernetics and brain simulation, symbolic, cognitive simulation, logic-based, anti-logic, knowledge-based, sub-symbolic, embodied intelligence, computational intelligence and soft computing, machine learning and statistics, and the like.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

Moreover, while illustrative aspects have been described herein, the scope includes any and all aspects having equivalent elements, modifications, omissions, combinations (e.g., of aspects across various aspects), adaptations or alterations based on the disclosure. Further, the steps of the disclosed methods can be modified in any manner, including by reordering steps or inserting or deleting steps.

What is claimed is:

1. A method for controlling material application in a material dispensing system, the method comprising:
implementing a conveyor configured to convey substrates along a dispense line at a speed;
implementing an application device configured to apply a desired amount of a material to each of the substrates;
implementing a pump configured to deliver the material at a pressure to the application device;
implementing a controller configured to receive a desired speed of the conveyor and control a speed of the conveyor to convey the substrates along the dispense line at the desired speed;
determining with the controller a target pressure of the material provided by the pump to the application device to provide the desired amount of the material to each of the substrates utilizing a control algorithm;
measuring an amount of material applied to a plurality of substrates by a pump;
comparing the material applied per substrate to a target value; and
adjusting a pressure of the pump based on the comparing the material applied per substrate to a target value.

2. The method for controlling material application in a material dispensing system of claim 1, wherein the control algorithm is configured to account for a non-linear relationship between the pressure of the material and the speed of the conveyor.

3. The method for controlling material application in a material dispensing system of claim 1, wherein the control algorithm is configured to account for a non-linear relationship of flow resistance of components of the material dispensing system for determining the pressure of the material and the speed of the conveyor.

4. The method for controlling material application in a material dispensing system of claim 1, wherein the controller determines the target pressure of the material provided by the pump to the application device based on the desired speed to provide the desired amount of the material to each of the substrates utilizing a non-linear control algorithm.

5. The method for controlling material application in a material dispensing system of claim 1, wherein the controller receives the desired speed to control the speed of the conveyor; and
wherein the controller determines the target pressure of the material provided by the pump to the application device based on the desired speed to provide the desired amount of the material to each of the substrates utilizing a non-linear control algorithm.

6. The method for controlling material application in a material dispensing system of claim 1, further comprising generating with the controller the control algorithm during operation of the material dispensing system at a plurality of line speeds by receiving for each of the plurality of line speeds of the conveyor an associated operational pressure of the material by the controller and/or a user interface that provides a desired amount of the material applied to the substrates.

7. The method for controlling material application in a material dispensing system of claim 6, further comprising associating and storing with the controller each of the plurality of line speeds of the conveyor and the associated operational pressure the material.

8. The method for controlling material application in a material dispensing system of claim 7, wherein the generating with the controller the control algorithm comprises generating an algorithm based on the plurality of line speeds of the conveyor and the associated operational pressure of the material with the controller to generate a pressure of the material for the desired amount of the material applied to the substrates at any speed of the conveyor for subsequent operation of the material dispensing system.

9. The method for controlling material application in a material dispensing system of claim 1, wherein the conveyor is configured to convey the substrates along the dispense line at variable speeds and/or one of multiple speeds.

10. The method for controlling material application in a material dispensing system of claim 1, wherein the material comprises an adhesive.

11. A material dispensing system, the material dispensing system comprising:
a conveyor configured to convey substrates along a dispense line at a speed;
an application device configured to apply a desired amount of a material to each of the substrates;
a pump configured to deliver the material at a pressure to the application device;
a controller configured to receive a desired speed of the conveyor and control a speed of the conveyor to convey the substrates along the dispense line at the desired speed;
the controller configured to determine a target pressure of the material provided by the pump to the application device to provide the desired amount of the material to each of the substrates utilizing a control algorithm;
a flow sensor configured to measure an amount of material applied to a plurality of substrates by a pump;
the controller configured to compare the material applied per substrate to a target value to generate a comparison value; and
the controller configured to adjust a pressure of the pump based on the comparison value.

12. The material dispensing system of claim 11, wherein the control algorithm is configured to account for a non-linear relationship between the pressure of the material and the speed of the conveyor.

13. The material dispensing system of claim 11, wherein the control algorithm is configured to account for a non-linear relationship of flow resistance of components of the material dispensing system for determining the pressure of the material and the speed of the conveyor.

14. The material dispensing system of claim 11, wherein the controller determines the target pressure of the material provided by the pump to the application device to provide the desired amount of the material to each of the substrates utilizing a non-linear control algorithm.

15. The material dispensing system of claim 11,
wherein the controller determines the target pressure of the material provided by the pump to the application device based on the desired speed to provide the desired amount of the material to each of the substrates utilizing a non-linear control algorithm.

16. The material dispensing system of claim 11, further comprising generating with the controller the control algorithm during operation of the material dispensing system at a plurality of line speeds by receiving for each of the plurality of line speeds of the conveyor an associated operational pressure of the material by the controller and/or a user interface that provides a desired amount of the material applied to the substrates.

17. The material dispensing system of claim 16, further comprising associating and storing with the controller each of the plurality of line speeds of the conveyor and the associated operational pressure the material.

18. The material dispensing system of claim 17, wherein the generating with the controller the control algorithm comprises generating an algorithm based on the plurality of line speeds of the conveyor and the associated operational pressure of the material with the controller to generate a pressure of the material for the desired amount of the material applied to the substrates at any speed of the conveyor for subsequent operation of the material dispensing system.

19. The material dispensing system of claim 11, wherein the conveyor is configured to convey the substrates along the dispense line at variable speeds and/or one of multiple speeds.

20. The material dispensing system of claim 11, wherein the material comprises an adhesive.
